(19) United States
(12) Patent Application Publication
(10) Pub. No.: US 2024/0014553 A1
(43) Pub. Date: Jan. 11, 2024

(54) TRANSMISSION APPARATUS AND SIGNAL TRANSMISSION METHOD

(71) Applicant: NIPPON TELEGRAPH AND TELEPHONE CORPORATION, Tokyo (JP)

(72) Inventors: Takayuki YAMADA, Tokyo (JP); Doohwan LEE, Tokyo (JP); Jun MASHINO, Tokyo (JP); Hirofumi SASAKI, Tokyo (JP); Yasunori YAGI, Tokyo (JP); Tomoki SEMOTO, Tokyo (JP)

(21) Appl. No.: 18/253,661

(22) PCT Filed: Nov. 24, 2020
(86) PCT No.: PCT/JP2020/043702

§ 371 Date: May 19, 2023

(51) Int. Cl. H01Q 3/40; H01Q 21/20

(52) U.S. Cl. CPC H01Q 3/40; H01Q 21/20

(57) ABSTRACT

A transmission device includes: a multiplex circular array antenna including a plurality of circular array antennas in which a plurality of antenna elements are arranged in a circle; a plurality of Butler circuits connected to the multiplex circular array antenna; and one or more Butler circuits connected to one or more linear array antennas including some antenna elements among the plurality of antenna elements of the multiplex circular array antenna.

### TECHNICAL FIELD

The present invention relates to a technique of spatially multiplexing and transmitting a radio signal by using an orbital angular momentum (OAM) of an electromagnetic wave.

### BACKGROUND ART

In recent years, a technique for improving a transmission capacity by spatially multiplexing and transmitting a radio signal by using OAM has been studied (for example, Non Patent Literature 1). In an electromagnetic wave having OAM, an equiphase surface is spirally distributed in a propagation direction around a propagation axis. Since electromagnetic waves having different OAM modes and propagating in the same direction have spatial phase distributions orthogonal to each other in a rotation axis direction, it is possible to multiplex and transmit signals by separating signals in respective OAM modes modulated with different signal sequences in a receiving station.

In a wireless communication system using the OAM multiplexing technique, spatial multiplexing transmission of different signal sequences can be realized by generating, combining, and transmitting a plurality of OAM modes by using a uniform circular array (hereinafter, referred to as a UCA) in which a plurality of antenna elements are circularly arranged at equal intervals (for example, Non Patent Literature 2). For example, a Butler circuit (Butler matrix circuit) is used to generate signals in a plurality of OAM modes.

Signals in the same OAM mode can be multiplexed and transmitted by a multiplex UCA in which a plurality of UCAs having different diameters are concentrically arranged. The signals multiplexed in the same OAM mode can be separated by using a MIMO technique on a receiving side.

### CITATION LIST

### Non Patent Literature

Non Patent Literature 1: J. Wang et al., “Terabit free-space data transmission employing orbital angular momentum multiplexing,” Nature Photonics, Vol. 6, pp. 488-496, July 2012.
Non Patent Literature 2: Y. Yan et al., “High-capacity millimeter-wave communications with orbital angular momentum multiplexing,” Nature Commun., vol. 5, p.4876, Sep. 2014.

### SUMMARY OF INVENTION

### Technical Problem

As described above, a transmission device using the UCA and the Butler circuit enables communication of a large capacity, but it is desired to support mobile communication in the future. In order to apply an OAM multiplex transmission technique to mobile communication, multi-directional support or movement followability that allow signals to be transmitted in multiple directions are required.

However, in the conventional wireless transmission technique using the UCA and the Butler circuit, in order to separate signals in a plurality of OAM modes without interference between the modes, it is necessary to install a transmission antenna and a reception antenna at positions facing each other on the front, and thus there is a problem that multi-direction non-support and low movement followability are caused because axial alignment is required.

The present invention has been made in view of the circumstances, and an object of the present invention is to provide a technique that enables multi-direction support and movement followability in a transmission device using a UCA and a Butler circuit.

### Solution to Problem

According to the disclosed technique, there is provided a transmission device including:
a multiplex circular array antenna including a plurality of circular array antennas in which a plurality of antenna elements are arranged in a circle;
a plurality of Butler circuits connected to the multiplex circular array antenna; and
one or more Butler circuits connected to one or more linear array antennas including some antenna elements among the plurality of antenna elements of the multiplex circular array antenna.

### Advantageous Effects of Invention

According to the disclosed technique, there is provided a technique that enables multi-directional support and movement followability in a transmission device using a UCA and a Butler circuit.

### BRIEF DESCRIPTION OF DRAWINGS

FIG. 1 is a diagram illustrating a phase setting example of a UCA for generating a signal in an OAM mode.

FIG. 2 is a diagram illustrating an example of a phase distribution and a signal intensity distribution of an OAM multiplex signal.

FIG. 3 is a diagram illustrating an example of an antenna configuration including a plurality of UCAs concentrically.

FIG. 4 is a diagram for describing a basic concept of the technique according to an embodiment of the present invention.

FIG. 5 is a diagram illustrating an outline of a transmission device according to the embodiment of the present invention.

FIG. 6 is a diagram illustrating a configuration example of the transmission device according to the embodiment of the present invention.

FIG. 7 is a diagram illustrating a configuration example of an OAM mode generation unit.

FIG. 8 is a diagram illustrating a connection configuration example of a Butler circuit and an antenna element.

FIG. 9 is a flowchart illustrating a flow of signal processing.

FIG. 10 is a diagram illustrating an example of a beam from a ULA.

FIG. 11 is a diagram illustrating an example of a beam from the ULA.

### DESCRIPTION OF EMBODIMENTS

Hereinafter, embodiments of the present invention (present embodiments) will be described with reference to the drawings. The embodiments described below are only examples, and embodiments to which the present invention is applied are not limited to the following embodiments.

### Basic Operation Example

First, a basic setting/operation example related to a UCA used in a transmission device in the present embodiment will be described.

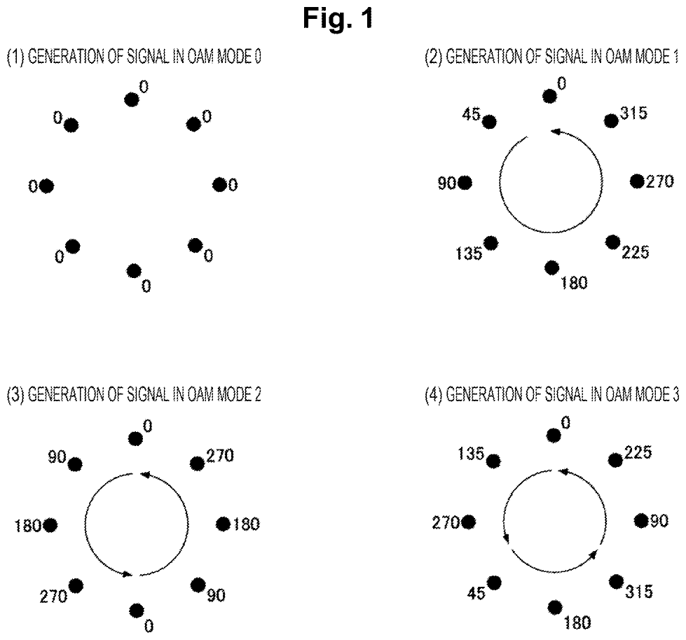

FIG. 1 illustrates a phase setting example of a UCA for generating a signal in an OAM mode. A UCA illustrated in FIG. 1 is a UCA including eight antenna elements.

In FIG. 1, signals in the OAM modes 0, 1, 2, 3, . . . on a transmission side are generated by phase differences of signals supplied to the antenna elements (indicated by •) of the UCA. That is, a signal in an OAM mode n is generated by setting a phase of the signal to be supplied to each antenna element such that the phase becomes n rotations (n×360 degrees). For example, in a case where the UCA includes m=8 antenna elements as illustrated in FIG. 1, and a signal in the OAM mode n=2 is generated, as illustrated in FIG. 1(3), a phase difference (0 degrees, 90 degrees, 180 degrees, 270 degrees, 0 degrees, 90 degrees, 180 degrees, 270 degrees) of 360 n/m=90 degrees is set in each antenna element counterclockwise such that the phase rotates twice.

A signal of which a phase rotation direction is reversed to the signal in the OAM mode n is referred to as an OAM mode-n. For example, a phase rotation direction of a signal in a positive OAM mode is set to the counterclockwise direction, and a phase rotation direction of a signal in a negative OAM mode is set to the clockwise direction.

Wireless communication using spatial multiplexing can be performed by generating different signal sequences as signals in different OAM modes and simultaneously transmitting the generated signals.

In order to separate an OAM multiplex signal on a reception side, a phase of each antenna element of a UCA on the reception side may be set to be reverse to a phase of an antenna element on the transmission side.

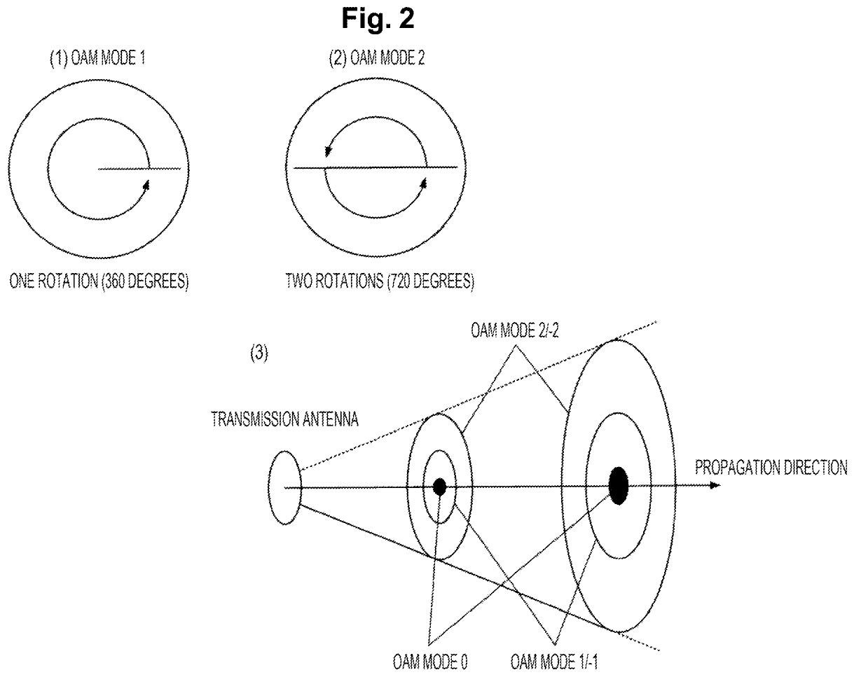

FIG. 2 illustrates an example of a phase distribution and a signal intensity distribution of an OAM multiplex signal. In FIGS. 2(1) and 2(2), phase distributions of signals in the OAM mode 1 and the OAM mode 2 viewed from the transmission side at an end face (propagation orthogonal plane) orthogonal to the propagation direction are indicated by arrows. The beginning of the arrow is 0 degrees, the phase changes linearly, and the end of the arrow is 360 degrees. That is, the signal in the OAM mode n propagates while the phase rotates by n (n×360 degrees) in the propagation orthogonal plane. The arrows of phase distributions of the signals in the OAM modes −1 and −2 are in reverse directions.

In the signal in each OAM mode, a signal intensity distribution and a position where the signal intensity is maximized are different for each OAM mode. However, the intensity distributions of the same OAM mode having different signs are the same. Specifically, as the OAM mode becomes higher, a position where the signal intensity is maximized becomes farther from the propagation axis (Non Patent Literature 2). Here, a mode having a greater value in the OAM mode will be referred to as a higher mode. For example, the signal in the OAM mode 3 is in a higher mode than the signals in the OAM mode 0, the OAM mode 1, and the OAM mode 2.

In FIG. 2(3), a position where the signal intensity is maximized is indicated by a circular ring for each OAM mode. As the OAM mode becomes higher, the position where the signal intensity is maximized becomes farther from the central axis, and a beam diameter of the OAM mode multiplex signal widens according to a propagation distance, and the circular ring indicating the position where the signal intensity is maximized widens for each OAM mode.

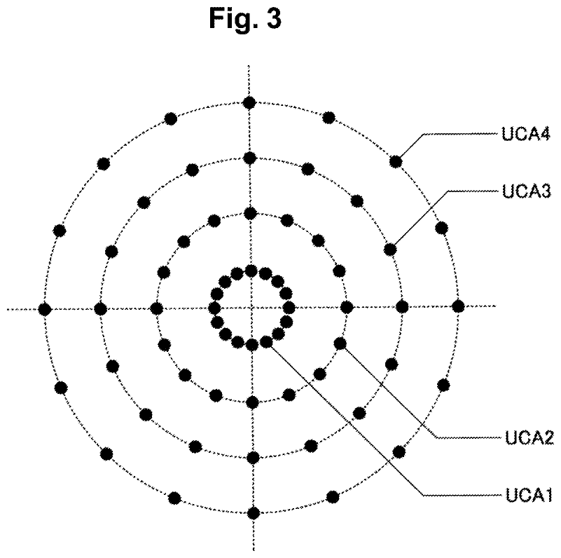

For example, as illustrated in FIG. 3, signals in the same OAM mode can be multiplexed and transmitted by a multiplex UCA in which a plurality of UCAs having different diameters are concentrically arranged. The signals multiplexed in the same OAM mode can be separated by using a MIMO technique on a receiving side. FIG. 3 illustrates an example of a multiplex UCA in which four UCAs having different diameters are arranged concentrically.

### Outline of Embodiment of Present Invention

As described above, the transmission device using the UCA and the Butler circuit enables large-capacity communication. However, in the conventional wireless transmission technique using the UCA and the Butler circuit, communication in multiple directions is not supported, and movement followability is also low.

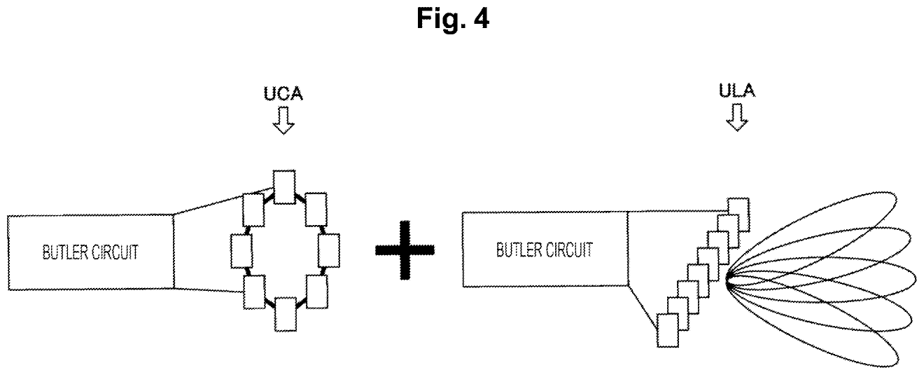

Therefore, in the present embodiment, as illustrated in FIG. 4, a transmission device is configured by combining a UCA and a uniform linear array (ULA). However, in the present embodiment, a multiplex UCA is used, and the ULA includes some antenna elements configuring the multiplex UCA.

The ULA is antenna in which a plurality of antenna elements are linearly arranged, and can dynamically generate beams in various directions inclined from the vertical direction to the antenna array by supplying a signal to each antenna element while changing a phase. Consequently, multi-directional support or movement followability can be realized.

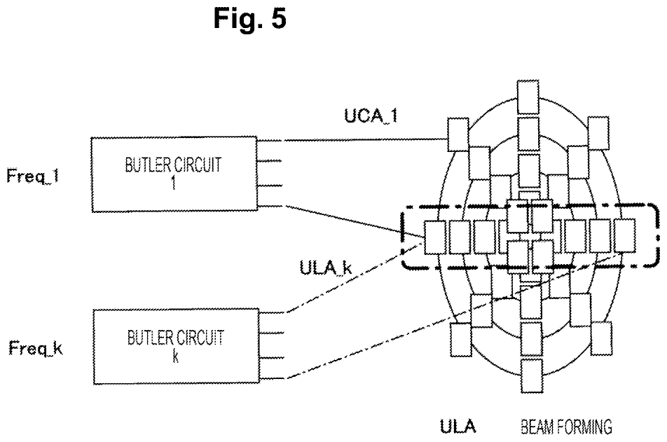

FIG. 5 is a diagram illustrating a schematic configuration of a transmission device in the present embodiment. As illustrated in FIG. 5, in the transmission device of the present embodiment, some antenna elements arranged linearly among antenna elements of a multiplex UCA having different concentric diameters are used as a ULA. Each antenna element configuring the multiplex UCA in the present embodiment is a wideband antenna element or an antenna element corresponding to a plurality of bands.

A Butler circuit that generates a signal having a phase difference is connected to each UCA configuring the multiplex UCA. A Butler circuit that generates a signal having a phase difference is also connected to each ULA.

For example, as illustrated in FIG. 5, in a case where the multiplex UCA includes four UCAs having different diameters, and four ULAs are configured in the multiplex UCA, eight Butler circuits are provided.

In the multiplex UCA in the present embodiment, corresponding frequency bands of the UCA and the ULA are different. Accordingly, the Butler circuit connected to the UCA and the Butler circuit connected to the ULA have different corresponding frequency bands. The corresponding frequency bands may be the same or different between the UCAs in the plurality of UCAs. The corresponding frequency bands may be the same or different between the ULAs in the plurality of ULAs.

In the present embodiment, by selecting one or more Butler circuits that supply signals to the array antenna, transmission by a multiplex UCA, transmission by a single UCA, transmission by a single ULA, transmission by a plurality of ULAs, transmission by a multiplex UCA and a single ULA, transmission by a multiplex UCA and a plurality of ULAs, and the like can be freely selected. In a case of using both the UCA and the ULA, the UCA and the ULA may be used asynchronously, or the UCA and the ULA may be used synchronously and simultaneously.

Hereinafter, examples of a configuration and an operation of the transmission device in the present embodiment will be described.

### EXAMPLES

### Device Configuration Example

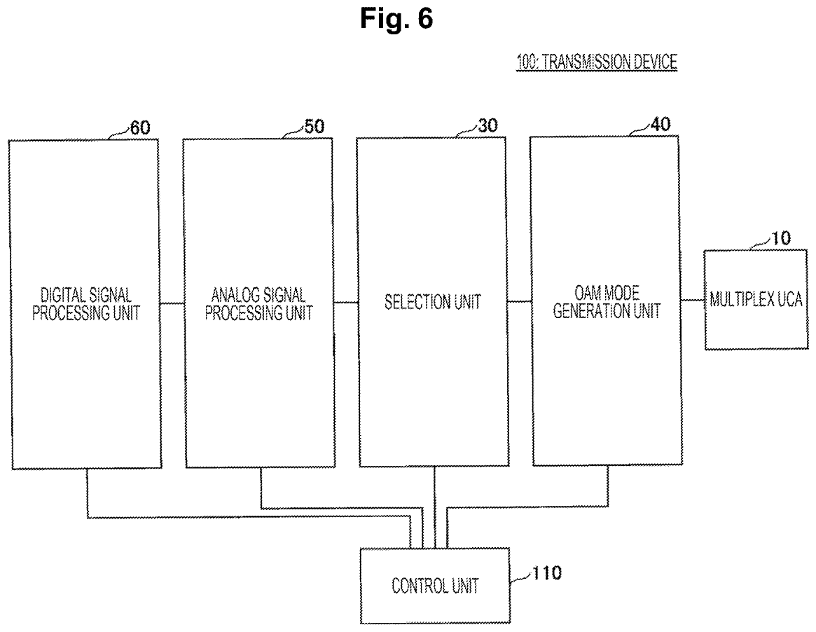

FIG. 6 is a configuration diagram of a transmission device 100 in the present example. As illustrated in FIG. 6, the transmission device 100 of the present example includes a multiplex UCA 10, an OAM mode generation unit a selection unit 30, an analog signal processing unit a digital signal processing unit 60, and a control unit 110.

The OAM mode generation unit 40 includes Butler circuits of a total number of a plurality of UCAs configuring the multiplex UCA 10 and the number of one or more ULAs using the antenna elements configuring the multiplex UCA 10.

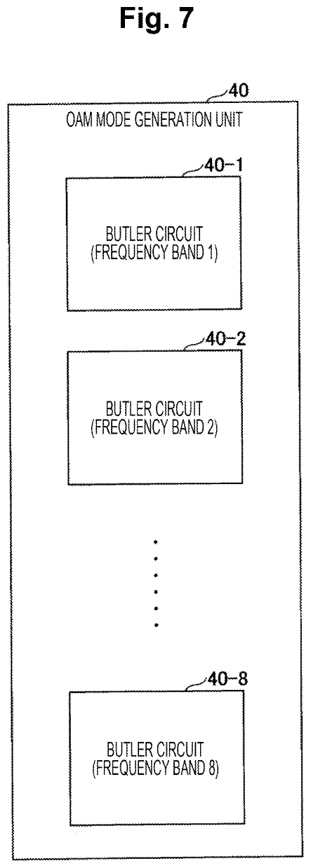

For example, in a case where the multiplex UCA 10 is an antenna including four UCAs (UCA_1, UCA_2, UCA_3, and UCA_4) having different diameters, and four ULAs (ULA 1, ULA 2, ULA 3, and ULA 4) are configured by the plurality of antenna elements configuring the multiplex UCA 10, as illustrated in FIG. 7, the OAM mode generation unit 40 includes eight Butler circuits 40-1 to 40-8 corresponding to the respective UCAs and the respective ULAs. For example, the Butler circuits 40-1 to 40-4 are connected to the UCA_1, the UCA_2, the UCA_3, and the UCA_4, and the Butler circuits 40-5 to 40-8 are connected to the ULA_1, the ULA_2, the ULA_3, and the ULA_4.

In the example in FIG. 7, the Butler circuit 40-1 corresponds to the frequency band 1 of the UCA_1 connected thereto, the Butler circuit 40-2 corresponds to the frequency band 2 of the UCA_2 connected thereto, the Butler circuit 40-3 corresponds to the frequency band 3 of the UCA_3 connected thereto, and the Butler circuit 40-4 corresponds to the frequency band 4 of the UCA_4 connected thereto. The Butler circuit 40-5 corresponds to the frequency band 5 of the ULA_1 connected thereto, the Butler circuit 40-6 corresponds to the frequency band 6 of the ULA_2 connected thereto, the Butler circuit 40-7 corresponds to the frequency band 7 of the ULA_3 connected thereto, and the Butler circuit 40-8 corresponds to the frequency band 8 of the ULA_4 connected thereto.

The frequency bands 1 to 8 may be different from each other, or some of the plurality of frequency bands may be the same.

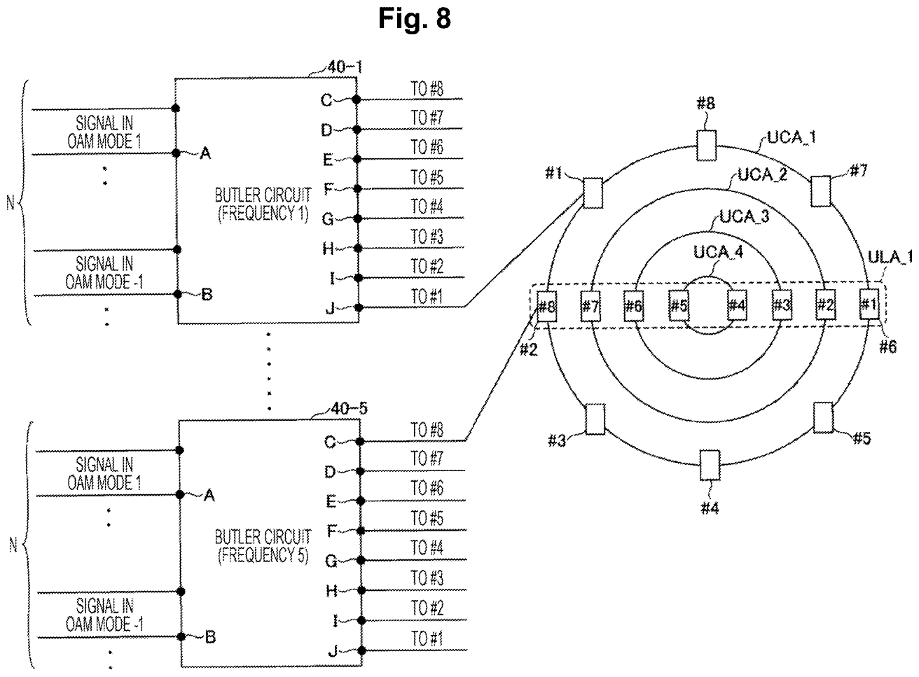

FIG. 8 illustrates a connection configuration example of the Butler circuit 40-1 and UCA_1 and a connection configuration example of the Butler circuit 40-5 and ULA_1 in a case where the multiplex UCA 10 is an antenna including four UCAs (UCA_1, UCA_2, UCA_3, and UCA_4) having different diameters, and four ULAs (ULA_1, ULA_2, ULA_3, and ULA_4) are configured by a plurality of antenna elements configuring the multiplex UCA 10. FIG. 8 illustrates a connection configuration for the UCA_1 and the ULA_1 as an example, but the same applies to other UCAs configuring the multiplex UCA 10 and other ULAs configured in the multiplex UCA 10.

Regarding the ULA, for example, an antenna element array on a line connecting antenna elements #3 and #7 of the UCA_1 configures the ULA_2, an antenna element array on a line connecting the antenna elements #4 and #8 of the UCA_1 configures the ULA_3, and an antenna element array on a line connecting the antenna elements #5 and #1 of the UCA_1 configures the ULA_4.

As illustrated in FIG. 8, the UCA_1 is an antenna in which eight antenna elements #1 to #8 are arranged in a circular shape. In the example illustrated in FIG. 8, a horizontal antenna array (an array of antenna elements on a straight line connecting the antenna elements #2 and #6 of the UCA_1) in FIG. 8 is used as a ULA (ULA_1) that receives a signal supplied from the Butler circuit 41-5.

The ULA_1 illustrated in FIG. 8 is an antenna in which the eight antenna elements #1 to #8 are linearly arranged. In the example in FIG. 8, among the eight antenna elements #1 to #8 of the ULA_1, the antenna elements #1 and #8 are a part of the UCA_1, the antenna elements #2 and #7 are a part of the UCA_2, the antenna elements #3 and #6 are a part of the UCA_3, and the antenna elements #4 and #5 are a part of the UCA_4.

FIG. 8 also illustrates that each Butler circuit has N input ports. Fundamentally, the number of output ports is a maximum quantity of N, and as in the example in FIG. 8, in a case where there are eight output ports, the maximum quantity of N is eight. The “port” may be referred to as a “terminal”. As will be described later, in the present example, as an example, a case where a signal having a phase difference corresponding to the OAM mode 1 and a signal having a phase difference corresponding to the OAM mode −1 are combined (multiplexed) and output is described.

As illustrated in FIG. 8, configurations in which the multiplex UCA 10 includes four UCAs, four ULAs are provided, the number of antenna elements of each of the UCA and the ULA is eight, a signal in the OAM mode 1 and a signal in the OAM mode −1 are multiplexed, and the like are examples. The multiplex UCA 10 may include more than four UCAs, or may include less than four UCAs. The number of ULAs may be more or less than four. The number of antenna elements of each of the UCA and the ULA may be more or less than eight. The number of OAM modes transmitted by each UCA may be more or less than two.

The Butler circuit 40-1 illustrated in FIG. 8 includes input ports A and B and output ports C to J. In the example illustrated in FIG. 8, a signal to be transmitted in the OAM mode 1 is input to the input port A, and a signal to be transmitted in the OAM mode −1 is input to the input port B.

A signal having a phase difference of 45° (360°/8) counterclockwise is output from each output port with respect to the input from the input port A, and a signal having a phase difference of −45° counterclockwise is output from each output port with respect to the input from the input port B. That is, in a case where there are inputs to both the input port A and the input port B, a signal obtained by combining (multiplexing) two signals having different phases is output from each output port.

Specifically, in the UCA_1, for convenience, assuming that the antenna element #1 is a reference (phase of 0°), a signal obtained by combining two signals having the following phases is output from each antenna element of the UCA_1.

The antenna element #1=(0°, 0°), the antenna element #2=(45°, −45°), the antenna element #3=(90°, −90°), the antenna element #4=(135°, −135°), the antenna element #5=(180°, −180°), the antenna element #6=(225°, −225°), the antenna element #7=(270°, −270°), and the antenna element #8=(315°, −315°).

The Butler circuit 40-5 connected to the ULA_1 has the same configuration as the Butler circuit 40-1 described above, and supplies a signal having the same phase difference as described above to the plurality of antenna elements #1 to #8 configuring the ULA_1.

In FIG. 8, input signals to the Butler circuit 40-5 connected to the ULA_1 are the signal in the OAM mode 1 and the signal in the OAM mode −1 for convenience. However, regarding the ULA, the signal in the OAM mode 1 input to the Butler circuit is a signal transmitted by a beam generated by a phase difference corresponding to the OAM mode 1, and the input signal in the OAM mode −1 is a signal transmitted by a beam generated by a phase difference corresponding to the OAM mode −1.

In the example in FIG. 8, the output port J of the Butler circuit 40-1 is connected to the antenna element #1 of the UCA_1, the output port I is connected to the antenna element #2 of the UCA_1, the output port H is connected to the antenna element #3 of the UCA_1, the output port G is connected to the antenna element #4 of the UCA_1, the output port F is connected to the antenna element #5 of the UCA_1, the output port E is connected to the antenna element #6 of the UCA_1, the output port D is connected to the antenna element #7 of the UCA_1, and the output port C is connected to the antenna element #8 of the UCA_1.

The output port J of the Butler circuit 40-5 is connected to the antenna element #1 of the ULA_1, the output port I is connected to the antenna element #2 of the ULA_1, the output port H is connected to the antenna element #3 of the ULA_1, the output port G is connected to the antenna element #4 of the ULA_1, the output port F is connected to the antenna element #5 of the ULA_1, the output port E is connected to the antenna element #6 of the ULA_1, the output port D is connected to the antenna element #7 of the ULA_1, and the output port C is connected to the antenna element #8 of the ULA_1.

For convenience of illustration, FIG. 8 illustrates connection of only some output ports. A signal output from each output port is supplied to an antenna element connected to the output port, and is output as a radio wave from the antenna element.

### Operation Example

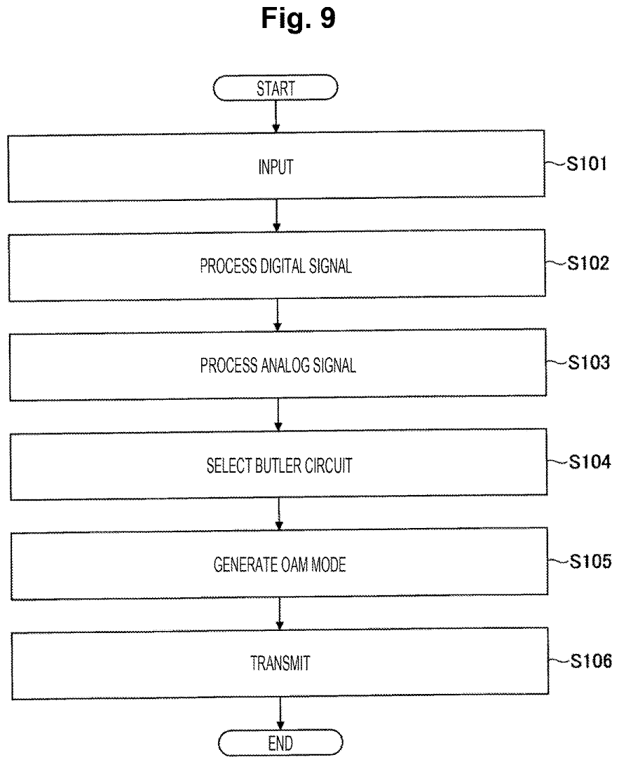

An operation example of the transmission device 100 illustrated in FIG. 6 in the present example will be described with reference to a flowchart of FIG. 9.

In S101, data is input to the digital signal processing unit 60. In S102, the digital signal processing unit 60 generates a digital signal to be transmitted on a carrier wave from input data, and outputs the generated digital signal to the analog signal processing unit 50.

In S103, the analog signal processing unit 50 converts the digital signal into an analog signal (digital-analog conversion), and converts a frequency of the output signal into a frequency band (for example, 28 GHz band) of a carrier wave. The analog signal processing unit 50 inputs the generated analog signal to the selection unit 30.

More specifically, the analog signal processing unit generates a signal with a frequency band (that is, corresponding to each of the Butler circuits connected to the UCA and the ULA) corresponding to each of the UCA and the ULA (only the UCA may be used, or only the ULA may be used) selected by the selection unit 30, and inputs the signal to the selection unit 30. Such control is executed, for example, according to an instruction from the control unit 110.

In S104, the selection unit 30 selects Butler circuits connected to a UCA and a ULA to transmit signals on the basis of an instruction from the control unit 110, and outputs the signal received from the analog signal processing unit 50 to the selected Butler circuits. In this case, the selection unit 30 selects input ports of the Butler circuits according to an OAM mode of the signal to be transmitted, designated from the control unit 110 and a setting of a phase difference corresponding thereto. In S105, the signal output from the selected Butler circuit is supplied to each antenna element connected to the Butler circuit, and the signal is transmitted from each antenna element.

The description will be made by using the example in FIG. 8. For example, when the control unit 110 determines to transmit signals from the UCA_1 and the ULA_1, the control unit 110 instructs the analog signal processing unit 50 to generate a signal with a frequency band corresponding to the UCA_1 (a signal to be transmitted in the OAM mode 1 and a signal to be transmitted in the OAM mode −1) and generate a signal with a frequency band corresponding to the ULA_1 (a signal transmitted with a phase difference in the OAM mode 1 and a signal transmitted with a phase difference in the OAM mode −1). The control unit 110 instructs the selection unit 30 to output the signal with the frequency band corresponding to the UCA_1 to the Butler circuit 40-1 and output the signal with the frequency band corresponding to the ULA_1 to the Butler circuit 40-5. In this case, each OAM mode and a signal with each phase difference corresponding thereto are output to the corresponding input port of each Butler circuit.

The analog signal processing unit 50 and the selection unit 30 operate according to the above instructions. Consequently, a signal into which the OAM mode 1 and the OAM mode −1 are multiplexed is transmitted from the UCA_1, and a signal is transmitted from the ULA_1 by a beam corresponding to the phase difference in the OAM mode 1 and a beam corresponding to the phase difference in the OAM mode −1.

In the above example, the analog signal processing unit 50 generates signals with frequency bands corresponding to the UCA and the ULA, but alternatively, the selection unit 30 may perform frequency conversion to convert a frequency of the signal received from the analog signal processing unit 50 into a frequency in the frequency band of each of the UCA and the ULA to be selected and output the signal.

### Selection Example of UCA/ULA

An example of a method in which the control unit 110 of the transmission device 100 selects a UCA and a ULA to transmit signals will be described.

It is assumed that the control unit 110 ascertains a position of each reception device (which may be a direction in which the reception device is present with respect to the transmission device 100). Any method may be used as a method in which the control unit 110 ascertains a state on the reception side (the position of the reception device or the like). For example, the control unit 110 may ascertain the position of the reception device by receiving a reference signal transmitted from the reception device, or may ascertain the position of the reception device by receiving position information transmitted from the reception device. The position (a fixed position, a planned movement position at each time, or the like) of the reception device may be set in the control unit 110 in advance.

For example, in a case where the control unit 110 determines that the reception device is located at a position (a position facing the transmission device 100) where communication using the multiplex UCA 10 (or an independent UCA) can be performed and that the reception device is located at a position that is not a position where communication using the multiplex UCA can be performed, the control unit 110 instructs the analog signal processing unit 50 and the selection unit 30 to cause each UCA of the multiplex UCA 10 and a ULA (referred to as a ULA_x) to transmit signals.

In this case, a large-capacity signal is transmitted from the multiplex UCA 10. Since a plurality of signals having a phase difference are supplied to respective antenna elements of the ULA_x, the ULA_x can transmit signals having beams directed in a plurality of directions. The number of ULAs_x may be one or more.

The control unit 110 can select one or more ULAs_x according to the position of the reception device.

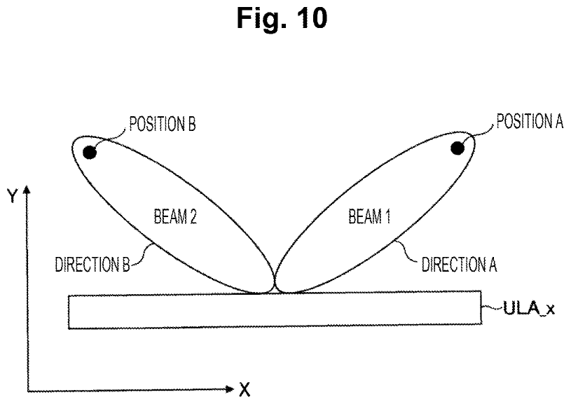

For example, for the sake of convenience, it is assumed that a circular face of the multiplex UCA 10 is perpendicular to the ground (a horizontal plane of X-Y), and a ULA that is parallel to the ground when the multiplex UCA 10 is viewed from above is the ULA_x illustrated in FIG. 10. In a case where the ULA_x can transmit a signal by using a beam 1 and a beam 2, for example, in a case where the control unit 110 ascertains that the reception device is present in directions of these beams, the control unit selects the ULA_x as a ULA, and selects an input port of the Butler circuit in accordance with a transmission direction. For example, in FIG. 8, in a case where it is desired to select the ULA_1 and transmit a signal in the direction of the beam 1, the control unit 110 instructs the selection unit 30 to select the input port A of the Butler circuit 40-5 and input a corresponding signal thereto.

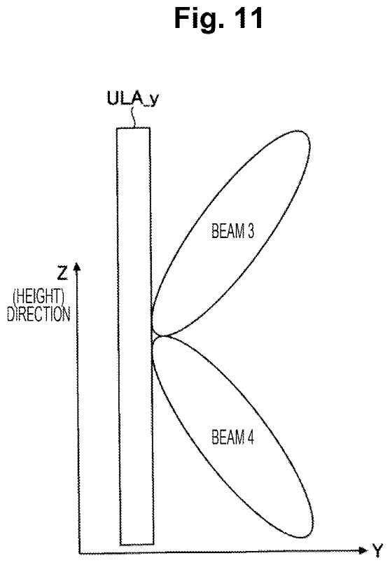

As illustrated in FIG. 11, it is assumed that a ULA_y is a ULA at a vertically standing position in the multiplex UCA 10, and a beam can be formed in the vertical direction as illustrated. In this case, for example, in a case where the control unit 110 ascertains that the reception device is present in a direction of a beam 3, the control unit may select the ULA_y as a ULA. The control unit 110 may select both the ULA_x and the ULA_y according to a position of the reception device.

A more specific description will be made by using a case of using the ULA_x illustrated in FIG. 10. For example, when the control unit 110 ascertains that the reception device is located at a position A, the control unit 110 causes the selection unit 30 to input only a signal to be transmitted in the direction A to the input port A of the corresponding Butler circuit. Consequently, the signal is transmitted from the ULA_x by the beam 1 in FIG. 10, and the reception device can receive the signal with high quality.

When the control unit 110 ascertains that the reception device has moved to a position B, the control unit 110 causes the selection unit 30 to switch a signal to be transmitted in the direction A to be input to the input port B, so that the signal is transmitted from the ULA_x by the beam 2 in FIG. 10, and thus the reception device can receive the signal with high quality.

Similarly, when the reception device moves to another position, the control unit 110 can supply the signal having the phase difference different from the phase difference corresponding to the OAM mode 1 to the ULA_x by switching the output of the signal transmitted in the OAM mode 1 to the input port n corresponding to the direction with respect to the selection unit 30, such that the direction of the beam can be changed. Thus, by using the ULA_x, a beam can be directed following the movement of the reception device.

When the control unit 110 ascertains that reception devices R1 and R2 are located at the different positions A and B, the control unit 110 causes the selection unit 30 to input a signal to be transmitted to the reception device R1 to the input port A and a signal to be transmitted to the reception device R2 to the input port B, so that the signals are transmitted from the ULA_x by using the beams 1 and 2 in FIG. 10, and the reception devices R1 and R2 can receive the signals with high quality.

Input timings of these signals to the input ports A and B may be the same or different. Signals can be transmitted simultaneously or individually in a plurality of directions according to the degree of freedom (the number of directions) of beam generation of the ULA_x and the number of input ports of the Butler circuit.

As described above, a beam direction can be changed with respect to a certain movement direction by selecting an input port of the Butler circuit corresponding to the ULA to be used. Then, by selecting the ULA, control of a beam direction that can be three-dimensionally followed can be realized.

By inputting a plurality of signals to different ports (or different ports of a Butler circuit corresponding to different ULAs), beams can be simultaneously output in a plurality of directions. OAM multiplex transmission by a UCA can be performed simultaneously with transmission by a ULA using beams in a plurality of directions.

That is, beams can be three-dimensionally directed in multiple directions by using an orientation of the multiplex UCA 10 or one or more selected ULAs. The movement followability can be performed by dynamically selecting a UCA and a ULA (corresponding Butler circuits and input ports thereof).

### Effects of Embodiment

The technique according to the present embodiment described above enables multi-direction support and movement followability in a transmission device using a UCA and a Butler circuit.

### Summary of Embodiment

In the present specification, at least the transmission device and the signal transmission method described in the following appendixes are described.

### (Appendix 1)

A transmission device including:
a multiplex circular array antenna including a plurality of circular array antennas in which a plurality of antenna elements are arranged in a circle;
a plurality of Butler circuits connected to the multiplex circular array antenna; and
one or more Butler circuits connected to one or more linear array antennas including some antenna elements among the plurality of antenna elements of the multiplex circular array antenna.

### (Appendix 2)

The transmission device according to Appendix 1, in which
a frequency band corresponding to the circular array antenna configuring the multiplex circular array antenna is different from a frequency band corresponding to the linear array antenna.

### (Appendix 3)

The transmission device according to Appendix 1 or 2 including:
a selection unit that selects a Butler circuit connected to a linear array antenna that transmits a signal or a circular array antenna that transmits a signal.

### (Appendix 4)

A signal transmission method in a transmission device including a multiplex circular array antenna including a plurality of circular array antennas in which a plurality of antenna elements are arranged in a circle, a plurality of Butler circuits connected to the multiplex circular array antenna, and one or more Butler circuits connected to one or more linear array antennas including some antenna elements among the plurality of antenna elements of the multiplex circular array antenna, the signal transmission method including:
selecting one or more Butler circuits from among the plurality of Butler circuits, and inputting a signal with a frequency band corresponding to an array antenna connected to the selected Butler circuit to the selected Butler circuit.

### (Appendix 5)

The signal transmission method according to Appendix 4, in which
one or more Butler circuits connected to one or more specific linear array antennas are selected, and the one or more specific linear array antennas are caused to transmit signals by using beams in a plurality of directions.

Although the present embodiment has been described above, the present invention is not limited to such a specific embodiment, and various modifications and changes can be made within the scope of the concept of the present invention described in the claims.

### REFERENCE SIGNS LIST

10 Multiplex UCA
30 Selection unit
40 OAM mode generation unit
50 Analog signal processing unit
60 Digital signal processing unit
100 Transmission device
110 Control unit

1. A transmission device comprising:
a multiplex circular array antenna including a plurality of circular array antennas in which a plurality of antenna elements are arranged in a circle;
a plurality of Butler circuits connected to the multiplex circular array antenna; and
one or more Butler circuits connected to one or more linear array antennas including some antenna elements among the plurality of antenna elements of the multiplex circular array antenna.

2. The transmission device according to claim 1, wherein a frequency band corresponding to the circular array antenna configuring the multiplex circular array antenna is different from a frequency band corresponding to the linear array antenna.

3. The transmission device according to claim 1, further comprising:
a selector configured to select a Butler circuit connected to a linear array antenna that transmits a signal or a circular array antenna that transmits a signal.

4. A signal transmission method executed by a transmission device including a multiplex circular array antenna including a plurality of circular array antennas in which a plurality of antenna elements are arranged in a circle, a plurality of Butler circuits connected to the multiplex circular array antenna, and one or more Butler circuits connected to one or more linear array antennas including some antenna elements among the plurality of antenna elements of the multiplex circular array antenna, the signal transmission method comprising:
selecting one or more Butler circuits from among the plurality of Butler circuits, and
inputting a signal with a frequency band corresponding to an array antenna connected to the selected Butler circuit to the selected Butler circuit.

5. The signal transmission method according to claim 4, wherein one or more Butler circuits connected to one or more specific linear array antennas are selected, and the one or more specific linear array antennas are caused to transmit signals by using beams in a plurality of directions.
